(19) United States
(12) Patent Application Publication
(10) Pub. No.: US 2009/0170474 A1
(43) Pub. Date: Jul. 2, 2009

(54) METHOD AND DEVICE FOR AUTHENTICATING TRUNKING CONTROL MESSAGES

(75) Inventor: MICHAEL W. BRIGHT, ARLINGTON HEIGHTS, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/964,942

(22) Filed: Dec. 27, 2007

(51) Int. Cl. H04M 1/66

(52) U.S. Cl. 455/411

(57) ABSTRACT

A transmitting device generates a header, at least one data block, a first message authentication code (MAC), and an authentication indicator to create a trunking control message. The trunking control message is transmitted to a receiving device, such that, upon receipt of the trunking control message by the receiving device, the receiving device can generate a second MAC. Once the second MAC is generated, the receiving device compares the second MAC to the first MAC. The at least one data block is determined to be authentic if the second MAC matches the first MAC. If the at least one data block is authentic, the receiving device processes the at least one data block; otherwise, the receiving device discards the trunking control message.

### FIELD OF THE DISCLOSURE

The disclosure relates to authenticating trunking control messages, and more particularly, trunking control messages having a trunk signaling block (TSBK) data block or multiple block trunking (MBT) data blocks.

### BACKGROUND OF THE DISCLOSURE

Project 25 (P25) is a set of standards that defines digital radio communications system architectures capable of being used by federal, state and local public safety agencies for voice and data communications. The Association of Public-Safety Communications Officials-International (APCO-International) adopted an initial standard, with participation by several radio equipment manufacturers. The initial standard became the APCO P25 Standard for Public Safety Digital Radio.

The P25 Standard was adopted by the Telecommunications Industry Association and Electronic Industries Alliance (TIA/EIA) as the TIA/EIA-102 Standard. The TIA/EIA organization facilitates the definition, interchangeability and maintenance for on-going developments relative to P25 standards. The P25 standard defines common parametric and operational methods for the radio systems to meet various system requirements.

In general, radio systems can be separated into conventional systems and trunked systems. A conventional system typically is characterized by a relatively simple geographically fixed infrastructure (such as a repeater network) that serves to repeat radio calls from one frequency to another. A trunked system is characterized by a controller in the infrastructure that assigns calls to specific channels. Trunking generally refers to the mutual sharing of a relatively small number of communication channels among a relatively large number of users. A trunking radio system provides the ability to send and receive voice and data information in a relatively efficient and cost-effective manner. P25 supports both conventional and trunked systems.

In P25 trunked operation, the controller uses dedicated control channels to coordinate user access. An outbound control channel is used to send information from the controller, and an inbound control channel is used to send information to the controller. P25 trunking control messages typically are provided in two formats: a trunking control message having a TSBK data block and a trunking control message having MBT data blocks.

P25 trunking control messages are used for many functions, including registering or authenticating a device within the system. Registration or authentication is performed to allow only authorized devices to access the system and its services, including the ability to communicate with other authorized system users/devices. Authenticating trunking control messages serves to verify that the device sending the trunking control message is authorized to do so. The P25 standard includes methods to authenticate devices when registering on the system. However, existing authentication methods do not authenticate each request for service or each trunking control message, such as a remote inhibit message or a remote monitor message.

### BRIEF DESCRIPTION OF THE FIGURES

FIG. 1 is an exemplary block diagram of a device suitable for use in a method for generating and authenticating trunking control messages in accordance with the present disclosure;

FIG. 2 is a flow chart that illustrates a method for generating and transmitting trunking control messages in accordance with the present disclosure;

FIG. 3 is an exemplary block diagram of a TSBK data block suitable for use with the present disclosure;

FIG. 4 is an exemplary block diagram of a data header suitable for use with a trunking control message having MBT data blocks in accordance with the present disclosure;

FIG. 5 is an exemplary block diagram of a redefined data header suitable for use with a trunking control message having MBT data blocks in accordance with the present disclosure;

FIG. 6 is an exemplary block diagram of a replay protection block (RPB) suitable for use with the present disclosure;

FIG. 7 is an exemplary block diagram of an authentication block suitable for use with the present disclosure;

FIG. 8 is a block diagram of examples of inbound and outbound trunking control messages having a TSBK data block in accordance with the present disclosure;

FIG. 9 is a block diagram of examples of inbound and outbound trunking control messages having MBT blocks in accordance with the present disclosure; and

FIG. 10 is a flow chart that illustrates a method for receiving trunking control messages in accordance with the present disclosure.

### DETAILED DESCRIPTION

In the following description, like reference numerals indicate like components to enhance the understanding of the methods and devices for generating and processing authenticated or non-authenticated trunking control messages. Also, although specific features, configurations and arrangements are discussed below, it should be understood that such specificity is for illustrative purposes only. A person skilled in the relevant art will recognize that other steps, configurations and arrangements are useful without departing from the spirit and scope of the disclosure.

In accordance with the present disclosure, if a trunking control message needs to be authentic, a transmitting device includes an authentication indicator to the trunking control message prior to transmission in order for a receiving device to authenticate the trunking control message before processing the data block(s); otherwise, the receiving device discards the message. Examples of authentication indicators include redefining the use of a unique Data Unit Identifier (DUID) or a service access point (SAP) identifier, and/or an authentication bit embedded in the data header. For ease of explanation, it should be understood that reference to authenticating the trunking control message or the trunking control message being authentic is equivalent to authenticating the TSBK data block or MBT data blocks that are a part of the trunking control message or that the TSBK data block/MBT data blocks are authentic; these phrases are used interchangeably throughout the document. The transmitting device further adds an Authentication Block (AB) having authentication information (e.g., a partial time field and a Message Authentication Code (MAC)) to the trunking control message. Upon receipt, if the trunking control message comprises an authentication indicator, the receiving device generates a MAC locally using information extracted from the received trunking control message, and compares the MAC generated locally with the MAC received in the trunking control message. If the MACs match, then the trunking control message is deemed authentic and the data is processed by the receiving device; otherwise the trunking control message is deemed non-authentic and discarded.

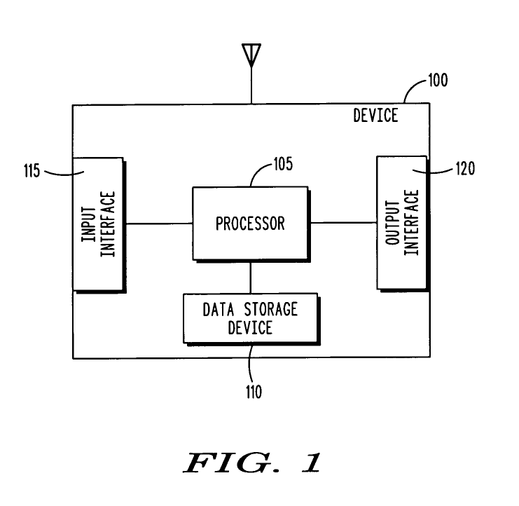

Let us now refer to the figures to describe the disclosure in greater detail. Referring now to FIG. 1, shown is an exemplary block diagram of a device 100 suitable for use in the methods described below. The device 100, for example, is configured for generating, transmitting, receiving and/or processing trunking control messages. The trunking control messages can either be authentic or non-authentic. Such a device 100 can be a subscriber unit, a mobile radio, a controller, a base station, a transceiver or any other suitable device.

In this example, the device 100 comprises a processor 105 and a data storage device 110 coupled to the processor 105. In general, the processor 105 controls the overall operation of the device 100, including the ability of the device 100 to generate, transmit, receive and/or process trunking control messages. The data storage device 110 can, for example, be any suitable memory device, such as a random access memory (RAM), a read-only memory (ROM) and/or a flash memory device. In general, the data storage device 110 stores logic, processing instructions and other information and data for the processor 105 (and other device components) to access. The processor 105 is also coupled to an input interface 115, which allows the device 100 to receive trunking control messages. The processor 105 is further coupled to an output interface 120, which allows the device 100 to transmit trunking control messages. One or more of the processor 105, the data storage device 110, the input interface 115 and the output interface 120 can be comprised partially or completely of any suitable structure or arrangement, e.g., one or more integrated circuits. Also, it should be understood that the device 100 includes other components, hardware and software (not shown) that are used for the operation of other features and functions of the device 100 not specifically described herein.

The device 100 can be partially or completely configured in the form of hardware circuitry and/or other hardware components within a larger device or group of components. Alternatively, the device 100 can be partially or completely configured in the form of software, e.g., as processing instructions and/or one or more sets of logic or computer code. In such a configuration, the logic or processing instructions typically are stored in the data storage device 110. The processor 105 accesses the necessary instructions from the data storage device 110 and executes the instructions or transfers the instructions to the appropriate location within the device 100.

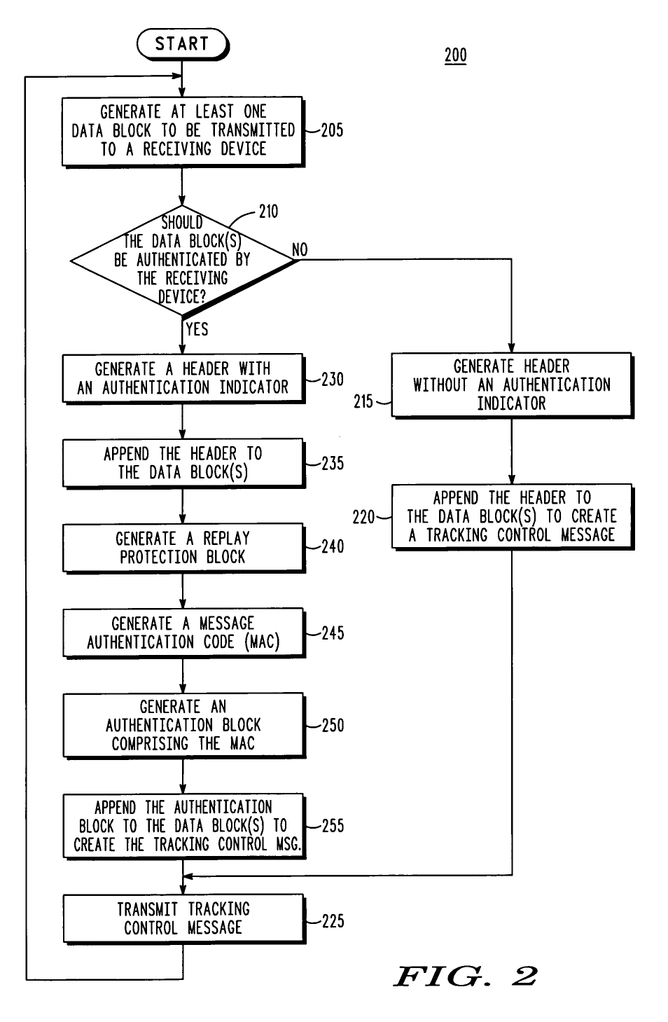

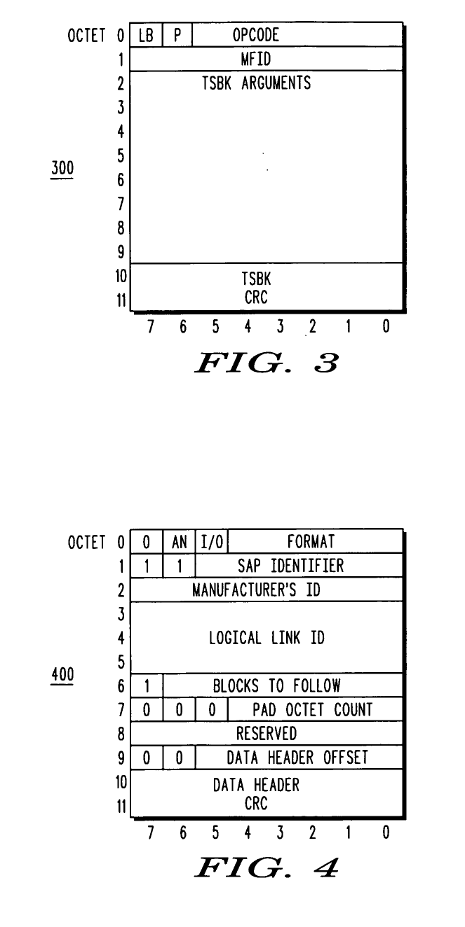

Referring now to FIG. 2, shown is a flow chart that illustrates an exemplary method 200 for generating a trunking control message. In FIG. 2, a transmitting device generates a at least one data block to be transmitted to the receiving device at step 205. The at least one data block can be either a TSBK data block or MBT data blocks. An example of a TSBK data block is illustrated in FIG. 3. In FIG. 3, the TSBK data block 300 is shown having twelve octets (octets 0-11), each having eights bits (bits 0-7), for a total of 96 bits. Channel coding prior to data transmission, such as trellis coding, often transforms the TSBK data block into 196 bits of actual transmitted data. Within the TSBK data block 300, the first octet (octet 0) is used for the last block (LB) flag or bit, the protected (P) flag or bit, and the opcode field information, which defines the type of TSBK data block 300. The next octet (octet 1) is used for the manufacturer's identifier (MFID). The next eight octets (octets 2-9) are used for arguments or the actual message information. The final two octets (octets 10-11) are used for the cyclical redundancy check (CRC), which is a validation check that the data was processed accurately. Octets 0-1 and 10-11 are common to all TSBK data blocks; octets 2-9 are unique to a specific TSBK data block.

Referring back again to FIG. 2, after the at least one data block is generated at step 205, the transmitting device determines whether the at least one data block should be authenticated by the receiving device at step 210 (i.e., whether the transmitting device should include an authentication indicator in the trunking control message (e.g., the header) for use by the receiving device). Whether or not the at least one data block is to be authenticated by the receiving device depends on a number of factors, including, for example, the contents of the trunking control message, the overall type of trunking control message, and its purpose within the communication system. Conventionally, not all trunking control messages/data block(s) are to be authenticated.

If the at least one data block does not need to be authentic, a header that does not include an authentication indicator, for example, is generated at step 215. It is important to note that in accordance with the present disclosure, if a TSBK data block was generated at step 205, then the header that is generated at step 215 is a message header (comprising a frame synchronization (FS) field and a network identifier (NID) field). If, however, MBT data blocks were generated at step 205, then the header that is generated at step 215 comprises a message header and a data header. After generation of the header at step 215, the TSBK data block or MBT data blocks is/are appended to the header to create the trunking control message at step 220, and the trunking control message is transmitted to the receiving device at step 225. Again, it is important to note that an authentication indicator is not included in the header of the trunking control message by the transmitting device at step 215 since the transmitting device determined that the at least one data block generated at step 205 did not need to be authentic in order for the receiving device to process the data block(s).

Returning back to step 210, if, however, the at least one data block needs to be authenticated by the receiving device in order the receiving device to process the data block(s), a header that includes an authentication indicator is generated at step 230. According to the present disclosure, the method used by the transmitting device to provide an authentication indicator for use by the receiving device depends on the type of trunking control message being generated. For example, if a TSBK data block was generated at step 205, the transmitting device may define (or redefine) the DUID, which is part of the NID field in the message header. Thus, as part of generating the header for a trunking control message having a TSBK data block at step 230, the NID portion of the header can be populated with a new DUID to indicate that an AB follows the TSBK data block, which would act as an authentication indicator for the receiving device. Moreover, the new DUID provides authentication information without redefining the data block, thus minimizing the possibilities of corrupting the data content of the data block.

If, on the other hand, MBT data blocks were generated at step 205, the transmitting device may define (or redefine) the data header portion of the header to include the authentication indicator. Thus, as part of generating the header for a trunking control message having MBT data blocks at step 230, the SAP identifier field in the data header can be set to indicate that an AB follows the MBT data blocks in the trunking control message, which would act as an authentication indicator for the receiving device. Alternatively, in a more general manner, one of the unused bits in the data header can be defined as an authentication bit and, depending on its state, will indicate whether an AB follows the MBT data blocks if the MBT data blocks should be authenticated by the receiving device. For example, bit 7 in octet 1 can be defined as an authentication bit. If the bit is set to logical 1, the MBT data blocks do not need to be authenticated by the receiving device, and the receiving device can proceed with processing the MBT data blocks; if the bit is set to logical 0, the MBT data blocks need to be authenticated by the receiving device, and an AB follows the MBT data blocks for use during authentication.

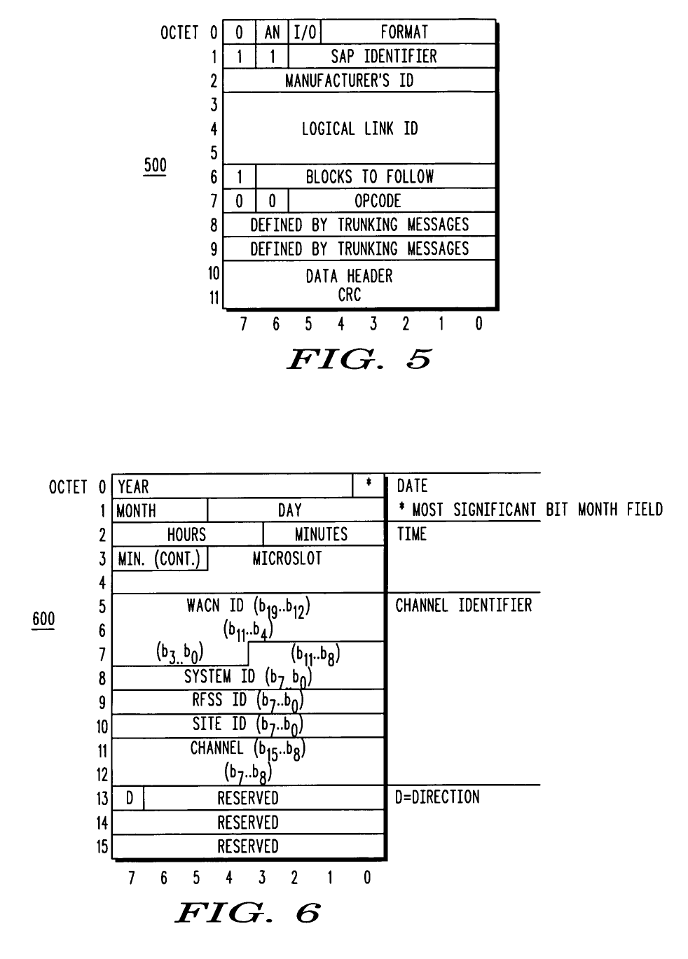

Examples of the data header are illustrated in FIGS. 4 and 5. The data header 400 may comprise, for example, a modified SAP identifier field in octet 1 as the authentication indicator for the receiving device. The data header 500 shown in FIG. 5 is similar to the data header 400 shown in FIG. 4, however, the data header 500 has three redefined octets, i.e., octets 7-9. The redefined octets provide two octets (octets 8-9) that are available to be defined by the data block to which the data header 500 is appended. Again, a modified SAP identifier field in octet 1 may be used as the authentication indicator for the receiving device.

Once the header is generated at step 230, and defined or redefined as discussed above, the transmitting device appends the TSBK data block or MBT data blocks to the header at step 235. The header can be appended to the TSBK data block or MBT data blocks at this point, or later in the process. As shown in later examples, the TSBK data block is appended to the NID field, which is a part of the header in this example. Also, as shown in later examples, the MBT data blocks are appended to the data header, which is part of the header. It should be understood that the header can include other fields, and that the data block(s) can be appended to other such fields as well.

Next, the transmitting device generates a RPB at step 240. An example of a RPB is illustrated in FIG. 6. The RPB can include sixteen eight-bit octets, for a total of 128 bits, which is the same size as the input register of an Advanced Encryption Standard (AES) algorithm. The RPB 600 includes current date and time fields (40 bits, octets 0-5), a channel address identification field (64 bits, octets 5-12), and a transmission direction (inbound or outbound) indicator field (1 bit in octet 13). The format of the RPB 600 includes 23 bits that are reserved for future use. The channel address and direction indicator fields are used to protect against message replay between different channels. The date and time fields of the RPB 600 can be used to prevent the replay of a non-authentic trunking control message/data block(s) at a later time.

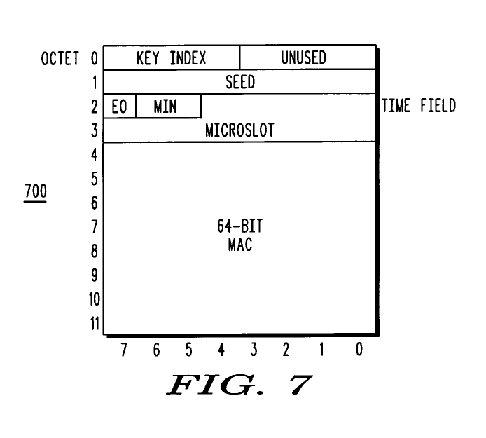

The RPB 600 is used by the transmitting device to generate the MAC at step 245, and the MAC will become part of the AB at step 250. Referring briefly to FIG. 7, shown is an exemplary block diagram of the AB 700. The AB 700 is shown having twelve octets (octets 0-11), each having eights bits (bits 0-7), for a total of 96 bits, although coding often transforms the AB 700 into 196 bits. The key index field in octet 0 and the seed field in octet 1 are used for key management. The AB 700 comprises a time field portion (octets 2-3), which includes an even/odd (E/O) bit, a minute field and a microslot field (i.e., the number of 7.5 microslot intervals; into the minute), to detect retransmissions. The AB 700 also includes a MAC field, which typically is a 64-bit (octets 4-11) field that comprises the result of a MAC algorithm, such as a cipher-based message authentication code (CMAC) algorithm (i.e., step 240), that will be used by the receiving device to authenticate the data block(s) in a trunking control message. One suitable CMAC algorithm is the CMAC mode for authentication for the AES algorithm, which is a conventional encryption algorithm. Typically, the MAC generated by the MAC algorithm is based on a number of inputs, including the RPB, the data in the TSBK data block or MBT data blocks, one or more encryption keys, and various fields from the AB 700.

According to the method 200, as part of generating the AB 700 at step 250, appropriate fields in the AB 700 are set to the time that is used in the RPB. For example, the E/O bit is set to the least significant bit of the hour field in the RPB. Also, the minute field in the AB is set to the two least significant bits of the minute field in the RPB. The microslot field in the AB 700 is set to the microslot value used in the RPB. It should be understood that other suitable field settings can be made either in addition to or instead of the AB settings recently discussed. It should also be noted that the AB is also another example of an authentication indicator for the receiving device. Thus, even if the header of the trunking control message does not contain an authentication indicator, the receiving device may still attempt to authenticate the message if it is aware that an AB 700 is appended to the message.

Once the AB is generated at step 250, the AB is appended to the end of the data block(s) at step 255. As noted above, appending the AB to the end of the data block(s) at step 255 is another authentication indicator provided by the transmitting device for use by the receiving device to authenticate the trunking control message. The presence of the AB 700 provides a general indication that the data block(s) within the given trunking control message is(are) to be authenticated by the receiving device. Also, the AB 700 can include suitable authentication information within various fields of the AB 700 for the TSBK data block or MBT data blocks contained within the trunking control message for use by the receiving device.

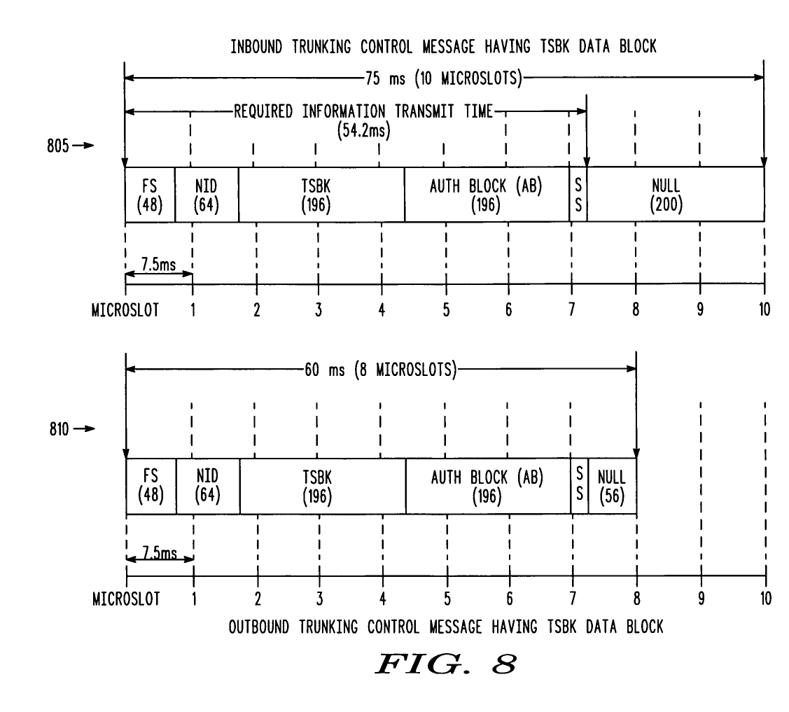

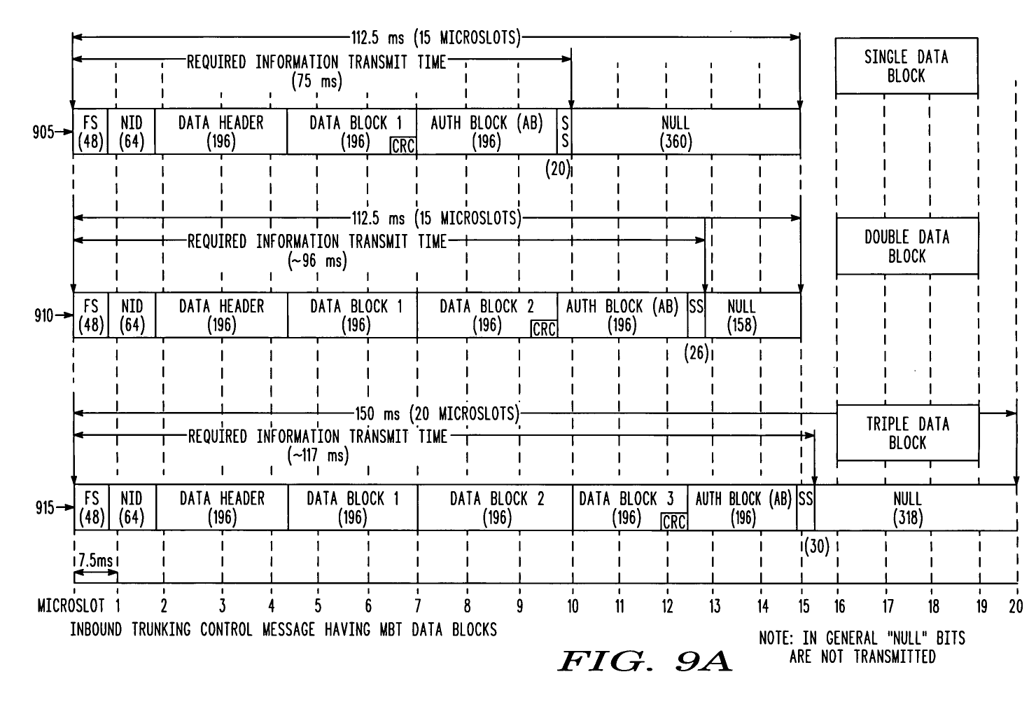

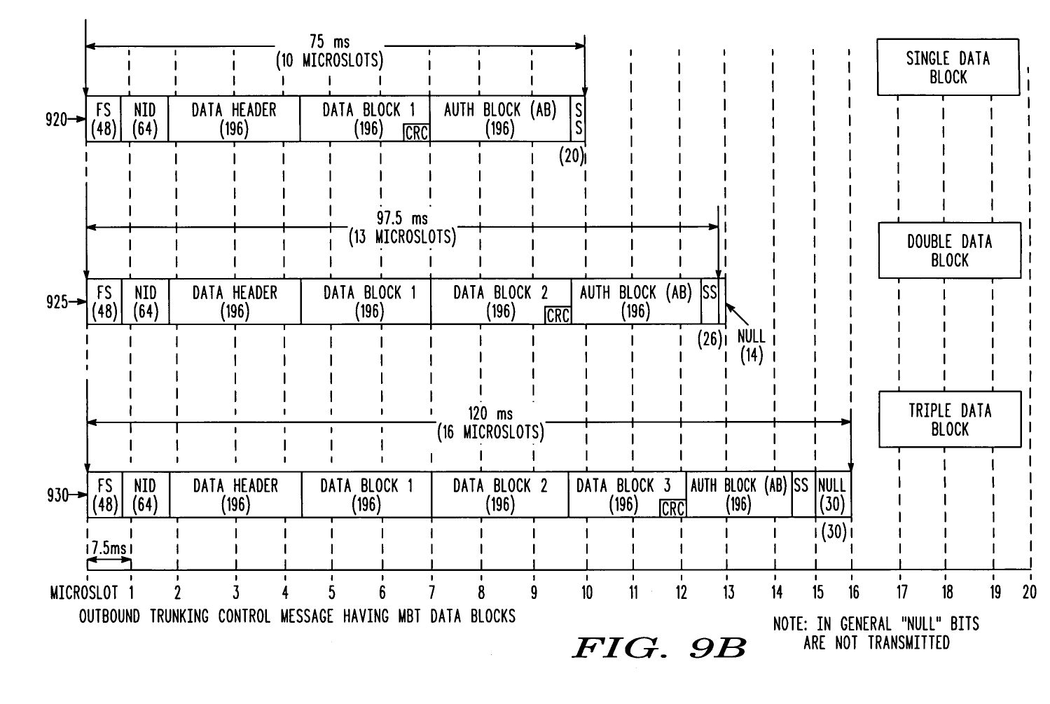

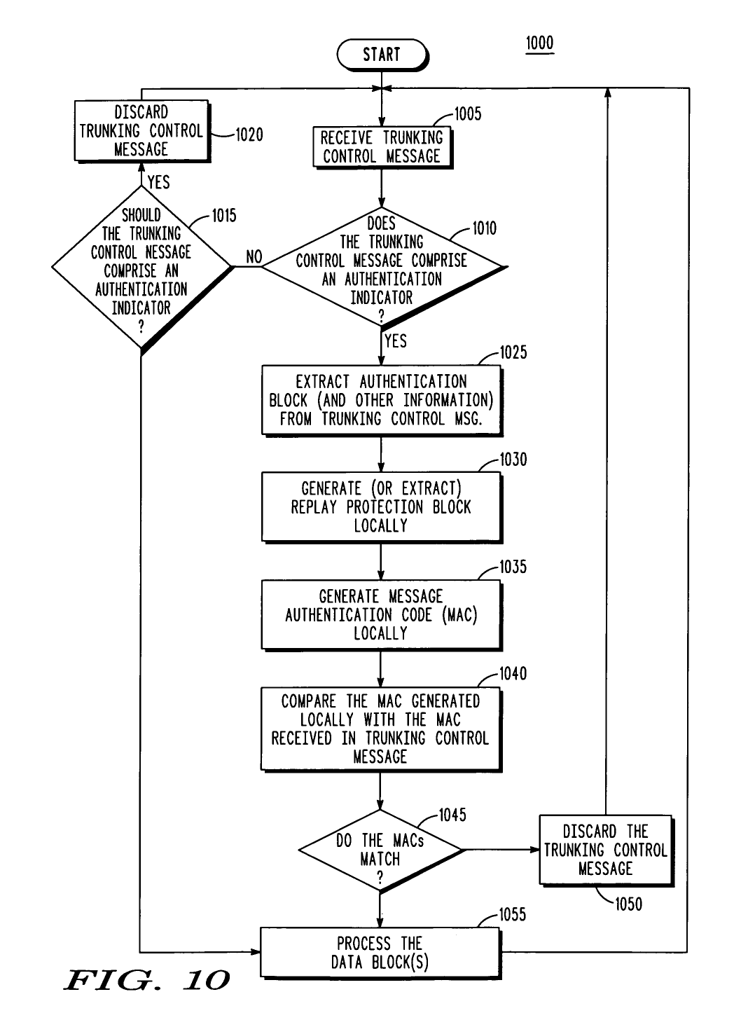

Once the AB has been appended to the TSBK data block or the MBT data blocks, the trunking control message is transmitted at step 225 (e.g., from the transmitting device 100 to a suitable receiving device, such as a base station, a controller, a repeater network or another device configured to receive transmitted trunking control messages). Examples of inbound and outbound trunking control messages are illustrated in FIGS. 8 and 9.

As illustrated in FIG. 8, the example of the inbound and outbound trunking control messages having a TSBK data block 805, 810, respectively, each can include a FS field, a NID field, the TSBK data block, the AB 700, and status symbols embedded throughout the trunking control message, but for simplicity, depicted as a single block of status symbols in the figure. The trunking control message having a TSBK data block and an AB can be transmitted in a multiple data block format, e.g., similar to a one-block MBT (two data blocks). As shown, the AB 700 is typically appended to the end of the TSBK data block, but does not necessarily have to be appended at this location.

As illustrated in FIG. 9, the examples of the inbound and outbound trunking control messages having MBT data blocks each have the AB 700 appended to the end of the last MBT data block. As you will note, trunking control messages having MBT data blocks can have any number of data blocks. In a first example 905, the inbound trunking control message comprises a header (the message header and a data header, collectively), a single data block and an AB. In a second example 910, the inbound trunking control message comprises a header, two data blocks and an AB. In a third example 915, the inbound trunking control message comprises a header, three data blocks and an AB. The examples for the outbound trunking control messages, 920, 925 and 930, follow the same structure as the inbound trunking control messages with respect to the number of data blocks included in the MBT data blocks. Again, each of the trunking control messages, inbound and outbound, comprises embedded status symbols throughout the message, but for simplicity, depicted as a single block of status symbols in the examples. It should also be noted that, in these examples, the structure of the trunking control messages having MBT data blocks are such that the header, and more specifically the data header portion, is appended to the front of the first of the one or more data blocks, and the AB is appended to the last of the one or more data blocks. Although the various fields and blocks shown may be structured according to conventional arrangements, it should be understood that, depending on the particular system within which the trunking control messages are transmitted, the arrangement of the various fields and data blocks can vary.

Referring now to FIG. 10, shown is a flow chart that illustrates an exemplary method 1000 for receiving and authenticating trunking control messages. As discussed previously, in general, within a trunking system, trunking control messages transmitted from a transmitting device are received and authenticated by a suitable receiving device (e.g., a controller or other suitable system equipment configured to verify that the transmitting device is authorized to use the trunking system and its messaging infrastructure). In general, the receiving device receives a trunking control message, determines the type of trunking control message (e.g., TSBK or MBT), and whether the trunking control message comprises an authentication indicator. If the received trunking control message does not comprise an authentication indicator, but it should have comprised an authentication indicator, the receiving device discards the trunking control message. If the received trunking control message does comprise an authentication indicator, the receiving device performs an authentication process to determine the authenticity of the trunking control message as described with reference to FIG. 10.

The authentication process 1000 starts by the receiving device receiving the trunking control message at step 1005 (the trunking control message was transmitted to the receiving device at step 225 in FIG. 2). Upon receipt, the receiving device determines whether the received trunking control message comprises an authentication indicator at step 1010. As discussed above, the header has a number of fields that include information about the remaining portion of the trunking control message, including its type. One or more fields in the header can be defined or redefined to indicate whether the receiving device should attempt to authenticate the trunking control message. It should be noted that the receiving device can look at other data blocks in the trunking control message, such as the AB 700, to determine whether it should attempt to authenticate the trunking control message as well. If it is determined that the received trunking control message does not comprise an authentication indicator, the receiving device determines whether the received trunking control message should have comprised an authentication indicator to be used by the receiving device at step 1015. If the received trunking control message should have comprised an authentication indicator, but does not, the receiving device essentially discards the trunking control message at step 1020, and waits for receipt of the next available trunking control message. If, however, the received trunking control message does not need to be authenticated by the receiving device, no authentication process is performed on the trunking control message and the TSBK data block or MBT data blocks is/are processed (e.g., in a conventional manner) by the receiving device at step 1055.

Returning back to step 1010, if the received trunking control message comprises an authentication indicator, the AB that is part of the trunking control message (along with other information, such as the received header, the data block(s), and the MAC generated by the transmitting device) is extracted at step 1025. As discussed previously herein, appropriate fields in the AB that were set by the transmitting device are used in the RPB at the receiving device. Such settings are used to assist the receiving device in authenticating the data block(s) in the received trunking control message.

In this example, once the AB is extracted at step 1025, the receiving device generates a RPB locally at step 1030. Here, the receiving device uses the RPB to prevent the playback of the trunking control message prior to authenticating the trunking control message. In this example, the RPB is generated at both the transmitting device and the receiving device, from information that is known at both devices. Therefore, the RPB does not have to be transmitted within the trunking control message, thus saving bandwidth on the channel. Alternatively, the transmitting device could have included the RPB within the trunking control message to prevent the receiving device from generating the RPB locally.

If the receiving device generates the RPB locally, however, the RPB is based on the current (local) time and the channel on which the trunking control message was received by the receiving device. That is, the current time is used to populate the date and time fields in the RPB. Also, the channel address information representing the channel that the trunking control message was received on is used to populate the channel address identification field (octets 5-12) and the transmission direction (inbound, in this case) indicator field (1 bit in octet 13) relative to the controller in the radio system infrastructure. Also, as part of generating the RPB locally at the receiving device at step 1030, the least significant bit of the hour field in the RPB is replaced with the E/O bit from the extracted AB (step 1025). Also, the two least significant bits of the minute field in the RPB are replaced with the two bits from the minute field in the AB, and the microslot field is replaced with the AB microslot field. It should be understood that these bits were defined or redefined as part of generating the AB 700 by the transmitting device at step 250.

Once the RPB is generated locally (or received) by the receiving device, the receiving device generates a MAC locally at step 1035. The MAC is generated locally based on the TSBK data block or MBT data blocks from the received trunking control message. The MAC generated locally is also based on other information, including the redefined information from the RPB and the first 4 octets of the extracted AB (step 1025). The MAC generated locally also can be based on other appropriate information, such as various encryption keys.

At step 1040, the receiving device compares the MAC generated by the transmitting device at step 245, that was included as part of the received trunking control message, with the MAC that was generated locally at step 1035. At step 1045, the receiving device determines whether the MAC generated by the transmitted device at step 245 matches the MAC generated locally by the receiving device at step 1035. If the two MACs do not match at step 1045, the trunking control message is deemed non-authentic by the receiving device. In such a case, the receiving device discards the trunking control message at step 1050, and waits for receipt of the next available trunking control message. If, however, the two MACs match at step 145, the received trunking control message is deemed authentic by the receiving device. In such a case, the receiving device processes the TSBK data block or MBT data blocks at step 1055, and waits for receipt of the next available trunking control message.

Although the examples disclosed herein relate to devices generating trunking control messages in a trunked radio system, e.g., P25 trunked systems, and/or trunking control messages, it should be understood that the present disclosure also can apply to other radio systems and messages transmitted therein, including conventional radio systems and messages transmitted in conventional radio systems. The methods described in FIG. 2 and FIG. 10 may be implemented in a general, multi-purpose or single purpose processor. Such a processor will execute instructions, either at the assembly-, compiled- or machine-level, to perform that process. Those instructions can be written by one of ordinary skill in the art and stored or transmitted on a computer readable medium. The instructions may also be created using source code or any other known computer-aided design tool. A computer readable medium may be any medium capable of carrying those instructions and includes RAM, dynamic RAM (DRAM), flash memory, ROM, compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

After review of the present disclosure, it will be apparent to those skilled in the art that many changes and substitutions can be made to the methods and device without departing from the spirit and scope of the disclosure as defined by the appended claims and their full scope of equivalents.

1. A method comprising the steps of:
generating a header, at least one data block, a first message authentication code, and an authentication indicator to create a trunking control message; and
transmitting the trunking control message to a receiving device, such that, upon receipt of the trunking control message by the receiving device, the receiving device can generate a second message authentication code, compare the second message authentication code to the first message authentication code, determine that the at least one data block is authentic if the second message authentication code matches the first message authentication code, and process the at least one data block if the at least one data block is authentic; otherwise discard the trunking control message.

2. The method as recited in claim 1, wherein the authentication indicator is an existing field in the header redefined in such a way to indicate to the receiving device to authenticate the at least one data block prior to processing.

3. The method as recited in claim 1, wherein the header is a message header, and wherein the at least one data block is a trunk signaling block (TSBK) data block.

4. The method as recited in claim 3, wherein the message header comprises a data unit identifier (DUID), and wherein the authentication indicator is the DUID defined in such a way to indicate to the receiving device to authenticate the at least one data block prior to processing.

5. The method as recited in claim 1, wherein the header is a message header and a data header, and wherein the at least one data block is a multiple block trunking (MBT) data block or MBT data blocks.

6. The method as recited in claim 5, wherein a portion of the data header comprises at least one authentication bit, and wherein the method further comprises a step of setting the at least one authentication bit in such a way to indicate whether the trunking control message is authenticated.

7. The method as recited in claim 5, wherein a portion of the data header comprises a service access point (SAP) identifier, and wherein the authentication indicator is the SAP identifier defined in such a way to indicate to the receiving device to authenticate the at least one data block prior to processing.

8. A method comprising the steps of:
receiving a trunking control message having a header, authentication indicator, at least one data block, and a first message authentication code;
generating a second message authentication code based on at least the header, authentication information, and the at least one data block;
comparing the second message authentication code to the first message authentication code;
determining that the at least one data block is authentic if the second message authentication code matches the first message authentication code; and
processing the at least one data block if the at least one data block is authentic; otherwise, discarding the trunking control message.

9. The method as recited in claim 8, wherein the authentication indicator is an existing field in the header redefined in such a way to indicate to the receiving device to authenticate the at least one data block prior to processing.

10. The method as recited in claim 9, wherein the header is a message header, and wherein the at least one data block is a trunk signaling block (TSBK) data block, and wherein the existing field in the header is a data unit identifier (DUID).

11. The method as recited in claim 9, wherein the header is a message header and a data header, and wherein the at least one data block is a multiple block trunking (MBT) data block or MBT data blocks, and wherein the existing field in the header is a service access point (SAP) identifier.

12. The method as recited in claim 8, wherein the header is a message header and a data header, and wherein the at least one data block is a multiple block trunking (MBT) data block or MBT data blocks, and wherein the authentication indicator is an bit set in the data header.

13. The method as recited in claim 8 further comprising discarding the trunking control message if the second message authentication code does not match the first message authentication code.

14. The method as recited in claim 8, wherein the steps of generating, comparing and processing are performed only if the trunking control message further comprises an authentication indicator.

15. The method as recited in claim 8, wherein the trunking control message further comprises a time field portion defined based on a replay protection block (RPB) of the transmitting device, and wherein the second message authentication code is further based on the time field portion.

16. The method as recited in claim 8, further comprising the step of appending a replay protection block (RPB) to the beginning of the trunking control message, wherein the RPB prevents processing the at least one data block until it is determined that the second message authentication code matches the first message authentication code.

17. The method as recited in claim 8, wherein the at least one data block is a trunk signaling block (TSBK) data block.

18. The method as recited in claim 8, wherein the at least one data block is a multiple block trunking (MBT) data block or MBT data blocks.

19. The method as recited in claim 8, wherein the step of generating uses a cipher-based message authentication code (CMAC) algorithm to generate the second message authentication code.

20. The method as recited in claim 8, wherein the step of generating uses an Advanced Encryption Standard (AES) algorithm to generate the second message authentication code.
